(19) United States
(12) Patent Application Publication
(10) Pub. No.: US 2025/0314981 A1
(43) Pub. Date: Oct. 9, 2025

(54) NON-MAGNETIC ONE-COMPONENT TONER AND IMAGE FORMING APPARATUS

(71) Applicant: KYOCERA Document Solutions Inc., Osaka (JP)

(72) Inventors: Takeo MIZOBE, Osaka (JP); Takamichi MORI, Osaka (JP); Masashi YAMASHITA, Osaka (JP); Kohei TERASAKI, Osaka (JP); Norio KUBO, Osaka (JP); Ryo YAMADA, Osaka (JP)

(73) Assignee: KYOCERA Document Solutions Inc., Osaka (JP)

(21) Appl. No.: 19/091,311

(22) Filed: Mar. 26, 2025

(30) Foreign Application Priority Data
Apr. 4, 2024 (JP) 2024-060635

(51) Int. Cl. G03G 9/08; G03G 9/087; G03G 9/097; G03G 15/08

(52) U.S. Cl. CPC G03G 9/0825; G03G 9/0827; G03G 9/08755; G03G 9/09725; G03G 9/09766; G03G 15/08

(57) ABSTRACT

A non-magnetic one-component toner includes a toner particle. The toner particle includes a toner base particle and an external additive. The external additive includes a silica particle and a fluorine-containing particle. In predetermined printing in which a standard test page image defined in ISO 19752 is printed on 1000 sheets of recording media, a content Si₀ of the silica particles in the toner particles before the predetermined printing and a content Si_{1000D} of the silica particles in the toner particles in a development unit after the predetermined printing satisfy a formula (1) “0.5 Si_{1000D}/Si₀≤1.0”, and a content F₀ of the fluorine-containing particles in the toner particles before the predetermined printing and a content F_{1000D} of the fluorine-containing particles in the toner particles in the development unit after the predetermined printing satisfy a formula (2) “1.0≤F_{1000D}/F₀≤1.5”.

### INCORPORATION BY REFERENCE

This application is based upon and claims the benefit of priority from the corresponding Japanese Patent Application No. 2024-060635 (filed on Apr. 4, 2024), the entire contents of which are incorporated herein by reference.

### BACKGROUND

The present disclosure relates to a non-magnetic one-component toner and an image forming apparatus.

As dry development systems, there are a two-component development system and a one-component development system. In the two-component development system, a two-component developer which contains a toner and a carrier is used. In the one-component development system, a one-component developer which does not contain a toner and a carrier is used. Since no carrier is used, the one-component development system has the advantage that there is no deterioration of the carrier and there is no variation in the mixing ratio of the toner and carrier. The one-component development system also has the advantage of easily maintaining and managing an image forming apparatus and reducing the size thereof. Hence, various one-component developers which are used in the one-component development system have been studied.

### SUMMARY

A non-magnetic one-component toner according to the present disclosure includes a toner particle. The toner particle includes a toner base particle and an external additive that is adhered to the surface of the toner base particle. The external additive includes a silica particle and a fluorine-containing particle. In predetermined printing in which a standard test page image defined in ISO 19752 is printed on 1000 sheets of recording media, a content Si₀ of the silica particles in the toner particles before the predetermined printing and a content Si_{1000D} of the silica particles in the toner particles in a development unit after the predetermined printing satisfy a formula (1) below. A content F₀ of the fluorine-containing particles in the toner particles before the predetermined printing and a content F_{1000D} of the fluorine-containing particles in the toner particles in the development unit after the predetermined printing satisfy a formula (2) below.

$$0.5 \leq {Si}_{1000 D} / {Si}_{0} \leq 1. \qquad ( 1 )$$

$$1. \leq {F}_{1000 D} / {F}_{0} \leq 1.5 \qquad ( 2 )$$

An image forming apparatus according to the present disclosure includes: an image carrying member; and a development unit that supplies a non-magnetic one-component toner to an electrostatic latent image formed on the surface of the image carrying member. The non-magnetic one-component toner includes a toner particle. The toner particle includes a toner base particle and an external additive that is adhered to the surface of the toner base particle. The external additive includes a silica particle and a fluorine-containing particle. In predetermined printing in which a standard test page image defined in ISO 19752 is printed on 1000 sheets of recording media, a content Si₀ of the silica particles in the toner particles before the predetermined printing and a content Si_{1000D} of the silica particles in the toner particles in the development unit after the predetermined printing satisfy a formula (1) below. A content F₀ of the fluorine-containing particles in the toner particles before the predetermined printing and a content F_{1000D} of the fluorine-containing particles in the toner particles in the development unit after the predetermined printing satisfy a formula (2) below.

$$0.5 \leq {Si}_{1000 D} / {Si}_{0} \leq 1. \qquad ( 1 )$$

$$1. \leq {F}_{1000 D} / {F}_{0} \leq 1.5 \qquad ( 2 )$$

Further features of the present disclosure and specific advantages obtained by the present disclosure will become clearer from the following description of embodiments.

### BRIEF DESCRIPTION OF THE DRAWINGS

FIG. 1 is a diagram showing an image forming apparatus according to a second embodiment of the present disclosure;

FIG. 2 is an enlarged view of an image carrying member and a development unit shown in FIG. 1; and

FIG. 3 is an enlarged view of the image carrying member and a cleaning unit shown in FIG. 1.

### DETAILED DESCRIPTION

A problem in a conventional technology will first be described before the following description of embodiments of the present disclosure.

For example, a conventional positively charged toner for non-magnetic one-component development to be described below is provided. An external additive is externally added to a toner base particle in the positively charged toner for non-magnetic one-component development. The external additive contains: negatively charged resin fine particles which have an average particle diameter of 200 nm to 1000 nm and an electrical resistivity of 1×10¹⁵ Ω·cm or less; a silica which has an average particle diameter of 50 nm to 300 nm; a silica which has an average particle diameter equal to or greater than 5 nm and less than 50 nm; and polytetrafluoroethylene fine particles which have an average particle diameter of 100 nm to 1000 nm.

However, as a large number of sheets are printed, the amount of external additive included in the toner particles in an image forming apparatus is gradually changed. In the conventional positively charged toner for non-magnetic one-component development described above, no consideration is given to a change in the amount of external additive. Hence, when a large number of sheets are printed, the conventional positively charged toner for non-magnetic one-component development is insufficient in terms of stably forming high-quality images. Specifically, the conventional toner is insufficient in terms of forming, when a large number of sheets are printed, images which have a high image density, a small number of thin layer streaks and a small amount of fogging.

In view of the problem described above, an object of the present disclosure is to provide a non-magnetic one-component toner and an image forming apparatus which can form, even when a large number of sheets are printed, images having a high image density and a small number of thin layer streaks and a small amount of fogging.

Embodiments of the present disclosure will be described below. Terms which are used in the present specification will first be described. A non-magnetic one-component toner is an aggregate of toner particles (for example, powder). An external additive is an aggregate of external additive particles (for example, powder). Unless otherwise specified, evaluation results (for example, values indicating shapes and physical properties) of powder (for example, powder of toner particles and powder of external additive particles) are the number average of values measured for each of a considerable number of particles selected from the powder. Unless otherwise specified, a softening point (Tm) is a value measured using a high-temperature flow tester (“CFT-500D” made by Shimadzu Corporation). Unless otherwise specified, the volume median diameter (D₅₀) of powder is a median diameter measured using a laser diffraction/scattering type particle size distribution measuring device (for example, “Multisizer 3” made by Beckman Coulter, Inc.). Unless otherwise specified, the number average primary particle diameter of powder is the number average of the circle-equivalent diameters (Heywood diameter: the diameter of a circle having the same area as the projected area of a primary particle) of primary particles measured using a scanning electron microscope. Unless otherwise specified, the “main component” of a material means a component the amount of which is the largest in the material based on mass. The extent of hydrophobicity can be expressed, for example, by the contact angle of a water droplet (ease of wetting of water). As the contact angle of the water droplet is increased, the extent of hydrophobicity is increased. Components described in the present specification may be used alone or in combination of two or more. The terms used in the present specification have been described above.

### First Embodiment: Non-Magnetic One-Component Toner

The first embodiment of the present disclosure relates to a non-magnetic one-component toner. The non-magnetic one-component toner of the present disclosure includes a toner particle. The toner particle includes a toner base particle and an external additive which is adhered to the surface of the toner base particle. The external additive includes a silica particle and a fluorine-containing particle. In predetermined printing in which a standard test page image defined in ISO 19752 is printed on 1000 sheets of recording media, the content Si₀ of the silica particles in the toner particles before the predetermined printing and the content Si_{1000D} of the silica particles in the toner particles in a development unit after the predetermined printing satisfy a formula (1) “0.5≤Si_{1000D}/Si₀≤1.0”. The content F₀ of the fluorine-containing particles in the toner particles before the predetermined printing and the content F_{1000D} of the fluorine-containing particles in the toner particles in the development unit after the predetermined printing satisfy a formula (2) “1.0≤F_{1000D}/F₀≤1.5”.

In the following description, the “non-magnetic one-component toner” may be referred to as the “toner”. The “content Si₀ of the silica particles in the toner particles before the predetermined printing” may be referred to as the “initial silica content Si₀”. The “content Si_{1000D} of the silica particles in the toner particles in the development unit after the predetermined printing” may be referred to as the “development unit durable silica content Si_{1000D}”. The “content F₀ of the fluorine-containing particles in the toner particles before the predetermined printing” may be referred to as the “initial fluorine content F₀”. The “content F_{1000D} of the fluorine-containing particles in the toner particles in the development unit after the predetermined printing” may be referred to as the “development unit durable fluorine content F_{1000D}”. “Si_{1000D}/Si₀” in the formula (1) may be referred to as the “ratio (development unit durable silica content Si_{1000D}/initial silica content Si₀”. “F_{1000D}/F₀” in the formula (2) may be referred to as the “ratio (development unit durable fluorine content F_{1000D}/initial fluorine content F₀)”.

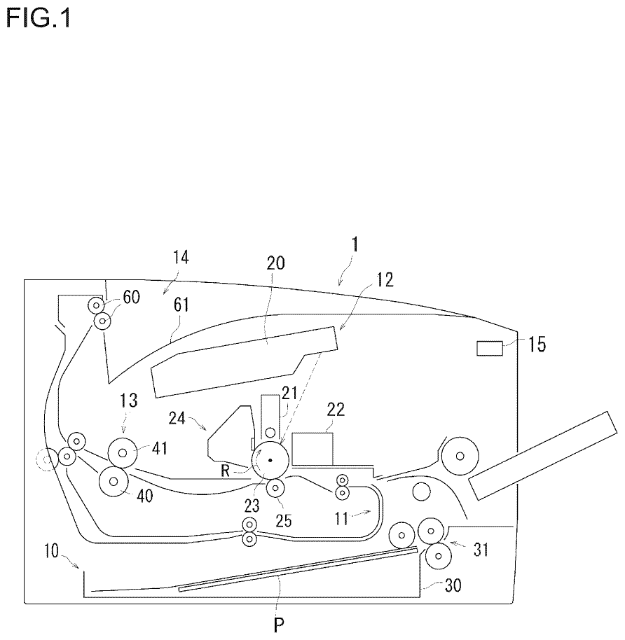

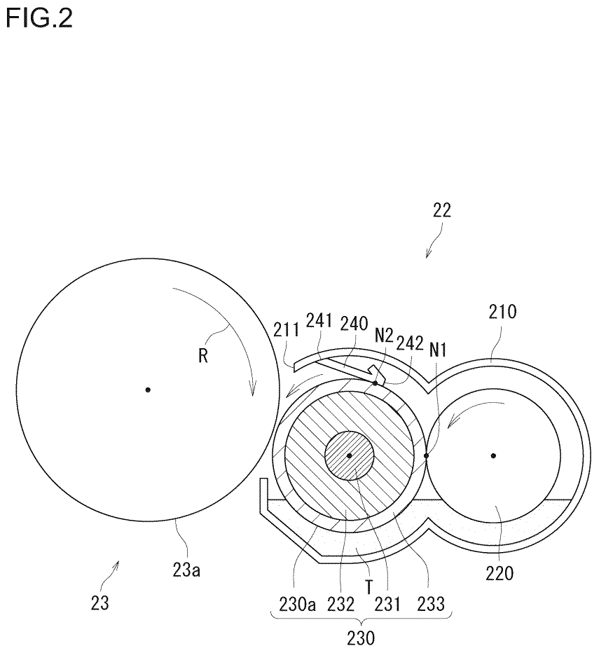

The toner of the present disclosure has the configuration described above, and thus even when a large number of sheets are printed, it is possible to form images which have a high image density, a small number of thin layer streaks and a small amount of fogging. The reason for this is presumed to be as follows. The reason will be described below with reference to FIGS. 1 and 2. FIG. 1 is a diagram showing an image forming apparatus 1 according to a second embodiment which will be described later. FIG. 2 is an enlarged view of an image carrying member 23 and a development unit 22 shown in FIG. 1.

For ease of understanding, an outline of the development unit 22 which adopts a non-magnetic one-component development system will first be described. As shown in FIG. 1, the image forming apparatus 1 includes the development unit 22 and the image carrying member 23. As shown in FIG. 2, the development unit 22 includes a storage frame 210, a supply roller 220, a development roller 230 and a restriction blade 240. The storage frame 210 stores a toner T therein. The supply roller 220 supplies the toner T stored inside the storage frame 210 to the development roller 230. The development roller 230 holds the toner T supplied from the supply roller 220 in the state of a toner layer (so-called a toner thin layer) on the surface (circumferential surface) 230a thereof. In a nip N2 between the restriction blade 240 and the development roller 230, the restriction blade 240 restricts the thickness of the toner layer held on the surface 230a of the development roller 230. The restricting of the thickness of the toner layer is to uniformly adjust the thickness of the toner layer to a predetermined value. After the restriction of the thickness, the toner T included in the toner layer is supplied from the surface 230a of the development roller 230 to an electrostatic latent image formed on the surface (circumferential surface) 23a of the image carrying member 23. Then, the electrostatic latent image is developed into a toner image. The outline of the development unit 22 which adopts the non-magnetic one-component development system has been described.

Here, in the nip N2, the toner T held on the development roller 230 may be fixedly adhered to the restriction blade 240. When the of the toner layer is restricted by the restriction blade 240 to which the toner T has been fixedly adhered, the thickness of the toner layer is nonuniform. Consequently, streaks (thin layer streaks) are generated in the formed image.

Hence, in the present disclosure, the external additive included in the toner particles includes the fluorine-containing particles. A part of the fluorine-containing particles which are separated from the toner base particles in the development unit 22 are adhered to the restriction blade 240. By the adhered fluorine-containing particles, the toner T is unlikely to be adhered to the restriction blade 240. Consequently, it is possible to suppress the generation of the thin layer streaks in the formed image.

On the other hand, if an excessive number of fluorine-containing particles are adhered to the restriction blade 240, the restriction blade 240 cannot sufficiently restrict the thickness of the toner layer. Hence, in the present disclosure, the external additive included in the toner particles includes the silica particles. The silica particles separated from the toner base particles in the development unit 22 scrape off the fluorine-containing particles adhered to the restriction blade 240. Then, an appropriate number of fluorine-containing particles adhered to the restriction blade 240 are kept.

Here, when printing is being performed using the image forming apparatus 1 filled with the toner T, the content of the fluorine-containing particles and the content of the silica particles in the development unit 22 are being changed. For example, the fluorine-containing particles separated from the toner base particles stay in the development unit 22, and thus the content of the fluorine-containing particles in the toner particles in the development unit 22 is increased. On the other hand, the fluorine-containing particles separated from the toner base particles are adhered to the restriction blade 240, and thus the content of the fluorine-containing particles in the toner particles in the development unit 22 is lowered. The fluorine-containing particles separated from the toner base particles are developed together with the toner T from the development roller 230 to the image carrying member 23, and thus the content of the fluorine-containing particles in the toner particles in the development unit 22 is lowered. The silica particles separated from the toner base particles stay in the development unit 22, and thus the content of the silica particles in the toner particles is increased. On the other hand, the silica particles separated from the toner base particles are developed together with the toner T from the development roller 230 to the image carrying member 23, and thus the content of the silica particles in the toner particles in the development unit 22 is lowered. As described above, when printing is continued, the content of the fluorine-containing particles and the content of the silica particles in the development unit 22 are changed. Hence, the amount of change of the content of the fluorine-containing particles and the amount of change of the content of the silica particles in the development unit 22 during printing are controlled, and thus this control is effective for stable toner layer formation and stable image formation during printing.

Hence, the toner T in the present disclosure satisfies the formula (2) “1.0≤F_{1000D}/F₀≤1.5”. When the ratio (development unit durable fluorine content F_{1000D}/initial fluorine content F₀) is equal to or greater than 1.0, after the predetermined printing, a sufficient number of fluorine-containing particles are present in the development unit 22. The sufficient number of fluorine-containing particles are adhered to the restriction blade 240, and thus the toner T is unlikely to be adhered to the restriction blade 240. Consequently, it is possible to suppress the generation of thin layer streaks in the formed image.

On the other hand, if an excessive number of fluorine-containing particles are adhered to the restriction blade 240, the restriction blade 240 cannot sufficiently restrict the thickness of the toner layer, and thus the thickness of the toner layer is increased. When the toner layer is thick, only an area in the vicinity of the surface of the toner layer is charged, and thus the entire toner layer is unlikely to be charged uniformly. Consequently, fogging occurs in the formed image. Hence, in the present disclosure, the ratio (development unit durable fluorine content F_{1000D}/initial fluorine content F₀) of the toner T is set equal to or less than 1.5. When the ratio (development unit durable fluorine content F_{1000D}/initial fluorine content F₀) is equal to or less than 1.5, after the predetermined printing, the number of fluorine-containing particles in the development unit 22 is prevented from being excessive. Since an excessive number of fluorine-containing particles are not adhered to the restriction blade 240, it is possible to suppress the generation of fogging in the formed image.

Furthermore, the toner T in the present disclosure satisfies the formula (1) “0.5 Si_{1000D}/Si₀≤1.0”. When the ratio (development unit durable silica content Si_{1000D}/initial silica content Si₀) exceeds 1.0, after the predetermined printing, an excessive number of silica particles are present in the development unit. The excessive number of silica particles excessively scrape off the fluorine-containing particles adhered to the restriction blade 240. Consequently, the toner T is adhered to the restriction blade 240, and thus thin layer streaks are generated in the formed image. Hence, in the present disclosure, the ratio (development unit durable silica content Si_{1000D}/initial silica content Si₀) of the toner T is set equal to or less than 1.0. In this way, it is possible to suppress the generation of thin layer streaks in the formed image.

The silica particles contribute not only to scraping off of the fluorine-containing particles adhered to the restriction blade 240 but also to charging of the toner particles. When the ratio (development unit durable silica content Si_{1000D}/initial silica content Si₀) is less than 0.5, after the predetermined printing, only a small number of silica particles are present in the development unit. Consequently, the toner particles cannot be charged to a desired value, and thus the image density of the formed image is lowered. Since the toner particles cannot be charged to the desired value, the thickness of the toner layer on the development roller 230 is excessively decreased, and thus thin layer streaks are generated in the formed image. Hence, in the present disclosure, the ratio (development unit durable silica content Si_{1000D}/initial silica content Si₀) is set equal to or greater than 0.5. In this way, an image which has a high image density can be formed, and thus it is possible to suppress the generation of thin layer streaks in the formed image.

The reason why it is possible to form images which have a high image density, a small number of thin layer streaks and a small amount of fogging even when a large number of sheets are printed using the toner in the present disclosure has been described above with reference to FIGS. 1 and 2.

The toner in the present disclosure is particularly suitable for use as a cartridge-type toner (non-magnetic one-component toner) without use of replenishment toner. In the cartridge-type toner without use of replenishment toner, toner particles which have high chargeability and a small diameter are developed preferentially over toner particles which have lower chargeability and a large diameter. Hence, the particle diameter distribution of the toners at an initial stage (for example, before the predetermined printing) is different from the particle diameter distribution of the toners after the printing (for example, after the predetermined printing). When the particle diameters of the toner particles are different, the amounts of external additive adhered to the toner base particles are different. As the particle diameter of the toner particles is decreased, the specific surface area per unit weight of the toner particles is increased, and thus the amount of external additive which can be adhered to the toner base particles is increased. On the other hand, as printing is performed, the particle diameter of the toner particles is increased, the specific surface area per unit weight of the toner particles is decreased, and thus the amount of external additive which can be adhered to the toner base particles is decreased. When the amount of external additive adhered to the toner base particles is decreased, the adhesive force of the toner to the restriction blade is increased, and thus the toner is easily and fixedly adhered to the restriction blade. Hence, in the cartridge-type toner without use of replenishment toner, thin layer streaks are particularly easily generated in the formed image. However, as already described, with the toner in the present disclosure, it is possible to suppress the generation of thin layer streaks in the formed image. The toner in the present disclosure satisfies the formula (1) and the formula (2) to be able to control a difference in the amount of external additive adhered to the toner base particles at the initial stage (for example, before the predetermined printing) and after the predetermined printing (for example, after the predetermined printing). Hence, the toner in the present disclosure can be particularly suitable for use as the cartridge-type toner without use of replenishment toner.

The toner in the present disclosure is particularly suitable for use as a toner which contains a mold release agent. When an image is formed using a toner containing a mold release agent, the thin layer streaks described above tend to be particularly generated. In terms of reducing the size and the cost of a fixing unit included in the image forming apparatus, a fixing unit which does not include a fixing oil application mechanism or a fixing unit which reduces the amount of fixing oil applied may be used. In order to suppress an offset to the fixing unit as described above, a mold release agent may be included in the toner. However, if the toner contains a large amount of mold release agent, the amount of mold release agent on the surface of the toner is increased, and the toner is easily adhered to a restriction blade due to mechanical and thermal effects. For this reason, when an image is formed using a toner containing a mold release agent, thin layer streaks tend to be particularly generated in the formed image. However, as already described, with the toner in the present disclosure, it is possible to suppress the generation of thin layer streaks in the formed image. Hence, the toner in the present disclosure can be particularly suitable for use as a toner which contains a mold release agent.

### <Formula (3) and Formula (4)>

A formula (3) and a formula (4) will then be described. The content Si₀ of the silica particles in the toner particles before the predetermined printing and the content Si_{1000C} of the silica particles in the toner particles in a cleaning unit after the predetermined printing preferably satisfy the formula (3) “0.7≤Si_{1000C}/Si₀≤0.9”. The content F₀ of the fluorine-containing particles in the toner particles before the predetermined printing and the content F_{1000C} of the fluorine-containing particles in the toner particles in the cleaning unit after the predetermined printing preferably satisfy the formula (4) “2.0≤F_{1000C}/F₀≤2.5”.

In the following description, the “content Si_{1000C} of the silica particles in the toner particles in the cleaning unit after the predetermined printing” may be referred to as the “cleaning unit durable silica content Si_{1000C}”. “Si_{1000C}/Si₀” in the formula (3) may be referred to as the “ratio (cleaning unit durable silica content Si_{1000C}/initial silica content Si₀”. The “content F_{1000C} of the fluorine-containing particles in the toner particles in the cleaning unit after the predetermined printing” may be referred to as the “cleaning unit durable fluorine content F_{1000C}”. “F_{1000C}/F₀” in the formula (4) may be referred to as the “ratio (cleaning unit durable fluorine content F_{1000C}/initial fluorine content F₀).

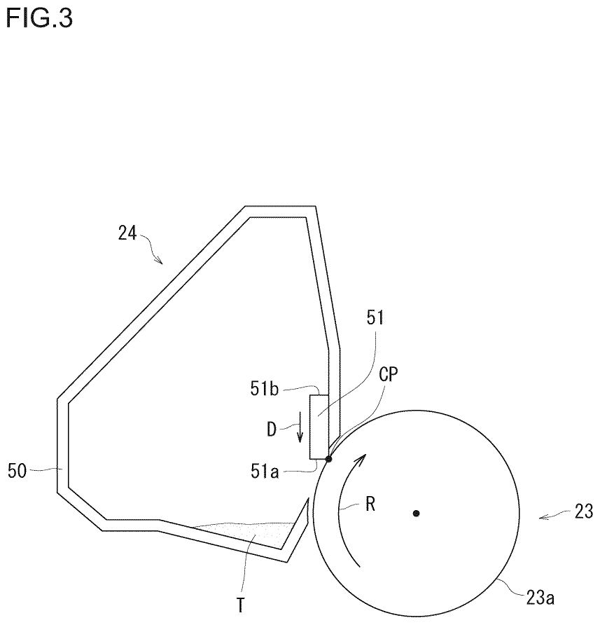

For ease of understanding, an outline of the cleaning unit 24 will be described with reference to FIGS. 1 and 3. FIG. 3 is an enlarged view of the image carrying member 23 and the cleaning unit 24 shown in FIG. 1. As shown in FIG. 1, the image forming apparatus 1 includes the cleaning unit 24 in addition to the image carrying member 23. The cleaning unit 24 includes a cleaning housing 50 and a cleaning member 51. As already described, the toner T is supplied from the surface 230a of the development roller 230 to the electrostatic latent image formed on the surface 23a of the image carrying member 23. Then, the toner T is transferred from the image carrying member 23 to a recording medium P. After the transfer, the toner T left on the surface 23a of the image carrying member 23 is removed by the cleaning member 51 which is pressed against the surface 23a of the image carrying member 23. The cleaning housing 50 collects the toner T removed by the cleaning member 51 thereinto. The outline of the cleaning unit 24 has been described above with reference to FIGS. 1 and 3.

Then, the formula (3) and the formula (4) will further be described with reference to FIG. 3 in particular. As printing is performed using the image forming apparatus 1 filled with the toner T, the content of the fluorine-containing particles and the content of the silica particles are changed in the cleaning unit 24. For example, when the number of fluorine-containing particles separated from the toner base particles on the image carrying member 23 is increased, the number of fluorine-containing particles collected from the surface 23a of the image carrying member 23 into the cleaning unit 24 is increased. Consequently, the content of the fluorine-containing particles in the toner particles in the cleaning unit 24 is increased. When the number of silica particles separated from the toner base particles on the image carrying member 23 is decreased, the number of silica particles collected from the surface 23a of the image carrying member 23 into the cleaning unit 24 is decreased. When the silica particles separated from the toner base particles are transferred from the image carrying member 23 to the recording medium P, the number of silica particles collected from the surface 23a of the image carrying member 23 into the cleaning unit 24 is decreased. Consequently, the content of the silica particles in the toner particles in the cleaning unit 24 is lowered. As described above, when printing is continued, the content of the fluorine-containing particles and the content of the silica particles in the cleaning unit 24 are changed. Hence, the amount of change of the content of the fluorine-containing particles and the amount of change of the content of the silica particles in the cleaning unit 24 during printing are controlled, and thus this control is effective for stable toner layer formation and stable image formation during printing.

Here, the toner T is fixedly adhered to the surface 23a of the image carrying member 23, and thus drum filming may occur. When drum filming occurs, a blank area may be generated in the formed image. The ratio (cleaning unit durable fluorine content F_{1000C}/initial fluorine content F₀) in the formula (4) is equal to or greater than 2.0, after the predetermined printing, a sufficient number of fluorine-containing particles are present in the cleaning unit 24. Then, a sufficient number of fluorine-containing particles are also present on the surface 23a of the image carrying member 23 before the fluorine-containing particles are collected into the cleaning unit 24. By the fluorine-containing particles which are present on the surface 23a of the image carrying member 23, the surface energy of the image carrying member 23 is lowered, and thus the toner T is unlikely to be adhered to the image carrying member 23. Consequently, drum filming is unlikely to occur, and thus it is possible to suppress the generation of a blank area caused by drum filming in the formed image.

On the other hand, when an excessive number of fluorine-containing particles are present on the surface 23a of the image carrying member 23, the charging potential of the image carrying member 23 is not increased to a desired value, and thus fogging may occur in the formed image. When the ratio (cleaning unit durable fluorine content F_{1000C}/initial fluorine content F₀) in the formula (4) is equal to or less than 2.5, an appropriate number of fluorine-containing particles are present in the cleaning unit 24 after the predetermined printing, and hence on the surface 23a of the image carrying member 23. Consequently, the charging potential of the image carrying member 23 can be increased to the desired value, and thus it is possible to suppress the occurrence of fogging in the formed image.

On the other hand, when an excessive number of silica particles are present on the surface 23a of the image carrying member 23, the fluorine-containing particles which are present on the surface 23a of the image carrying member 23 may be excessively scraped off. When the ratio (cleaning unit durable silica content Si_{1000C}/initial silica content Si₀) in the formula (3) is equal to or less than 0.9, an appropriate number of silica particles are present in the cleaning unit 24 after the predetermined printing, and hence on the surface 23a of the image carrying member 23. The fluorine-containing particles present on the surface 23a of the image carrying member 23 are appropriately scraped off by the appropriate number of silica particles. Consequently, the appropriate number of fluorine-containing particles present on the surface 23a of the image carrying member 23 are kept, and thus the toner T is unlikely to be adhered to the image carrying member 23. Consequently, drum filming is unlikely to occur, and thus it is possible to suppress the generation of a blank area caused by drum filming in the formed image.

When the ratio (cleaning unit durable silica content Si_{1000C}/initial silica content Si₀) in the formula (3) is equal to or greater than 0.7, the toner particles include a sufficient number of silica particles even after the predetermined printing. Since the silica particles contribute to charging of the toner particles, the toner particles including a sufficient number of silica particles are charged to a desired value. Consequently, it is possible to form images which have a high image density. The formula (3) and the formula (4) have been described above with reference to FIG. 3 in particular.

In order to balance the number of fluorine-containing particles adhered to the restriction blade or the image carrying member and the number of fluorine-containing particles scraped off by the silica particles, the ratio Si₀/F₀ of the initial silica content Si₀ to the initial fluorine content F₀ is preferably equal to or greater than 2.5 but equal to or less than 5.0, and more preferably equal to or greater than 2.5 but equal to or less than 3.5.

In order to balance the number of fluorine-containing particles adhered to the restriction blade and the number of fluorine-containing particles scraped off by the silica particles, the ratio Si_{1000D}/F_{1000D} of the development unit durable silica content Si_{1000D} to the development unit durable fluorine content F_{1000D} is preferably equal to or greater than 1.5 but equal to or less than 3.0, and more preferably equal to or greater than 1.7 but equal to or less than 2.7.

In order to balance the number of fluorine-containing particles adhered to the image carrying member and the number of fluorine-containing particles scraped off by the silica particles, the ratio Si_{1000C}/F_{1000C} of the cleaning unit durable silica content Si_{1000C} to the cleaning unit durable fluorine content F_{1000C} is preferably equal to or greater than 1.0 but equal to or less than 2.0, and more preferably equal to or greater than 0.9 but equal to or less than 1.8.

### <Predetermined Printing and Method for Measuring Contents>

The predetermined printing and a method for measuring the contents indicated in the formulae (1) to (4) will then be described. In the present specification, the “predetermined printing” is defined as printing of a standard test page image defined in ISO 19752 on 1000 sheets of recoding media. The standard test page image defined in ISO 19752 is a monochrome image used to test the number of sheets which can be printed by a monochrome printer. The predetermined printing is performed using, for example, an image forming apparatus which is to be filled with the toner in the present disclosure. The initial silica content Si₀, the initial fluorine content F₀, the development unit durable silica content Si_{1000D}, the development unit durable fluorine content F_{1000D}, the cleaning unit durable silica content Si_{1000C} and the cleaning unit durable fluorine content F_{1000C} are measured in the predetermined printing using the toner (in other words, measure by performing a predetermined printing test on the toner).

In the measurement of the initial silica content Si₀ and the initial fluorine content F₀, the toner before the predetermined printing (for example, the toner T before being filled in the development unit 22 shown in FIG. 2) is a measurement target. In the measurement of the development unit durable silica content Si_{1000D} and the development unit durable fluorine content F_{1000D}, the toner in the development unit after the predetermined printing (for example, the toner T present in the storage frame 210 included in the development unit 22 shown in FIG. 2, and more specifically, the toner T which is present in the storage frame 210 included in the development unit 22 shown in FIG. 2 and is present below the development roller 230) is a measurement target. In the measurement of the cleaning unit durable silica content Si_{1000C} and the cleaning unit durable fluorine content F_{1000C}, the toner in the cleaning unit after the predetermined printing (for example, the toner T present in the cleaning housing 50 included in the cleaning unit 24 shown in FIG. 3, more specifically, the toner T which is present in the cleaning housing 50 included in the cleaning unit 24 shown in FIG. 3 and is present below the cleaning member 51) is a measurement target.

On the measurement targets described above (more specifically, the toner before the predetermined printing, the toner T in the development unit after the predetermined printing and the toner in the cleaning unit after the predetermined printing), fluorescent X-ray analysis is performed to obtain fluorescent X-ray spectra including peaks derived from measured elements (Si and F). The X-ray intensity of the peak derived from the measured element Si in the fluorescent X-ray spectrum obtained is converted into the content (unit: mass %) of the silica particles in the toner particles. The X-ray intensity of the peak derived from the measured element F in the fluorescent X-ray spectrum is converted into the content (unit: mass %) of the fluorine-containing particles in the toner particles. In this way, for the measurement targets described above, the content of the silica particles in the toner particles and the content of the fluorine-containing particles in the toner particles are determined.

### <Toner Particles>

The toner particle includes the toner base particle and the external additive. The external additive is adhered to the surface of the toner base particle. The toner base particle may be a non-capsule toner particle which does not include a shell layer. The toner base particle may be a capsule toner particle which includes a toner core and a shell layer covering the toner core. The toner particles do not contain magnetic powder, and are used as a toner (that is, the non-magnetic one-component toner) without being mixed with a carrier. The toner including the toner particles is suitably used, for example, as a positively charged toner, for development of an electrostatic latent image. In the following description of the toner particles, the contents each indicate the contents before the predetermined printing.

### <External Additive>

The external additive includes the silica particles and the fluorine-containing particles. Although the external additive may include only the fluorine-containing particles and the silica particles, the external additive may further include particles other than the fluorine-containing particles and the silica particles (hereinafter also referred to as the “other external additive particles”).

### (Fluorine-Containing Particles)

The fluorine-containing particles include fluorine atoms. Examples of the fluorine-containing particles include fluorine resin particles. The fluorine resin particles contain a fluorine resin. The content of the fluorine resin in the fluorine resin particles is preferably equal to or greater than 80% by mass, more preferably equal to or greater than 95% by mass and further preferably equal to 100% by mass.

Examples of the fluorine resin include polytetrafluoroethylene (PTFE), perfluoroalkoxy fluororesin, polychlorotrifluoroethylene, polyvinylidene fluoride, polydichlorodifluoroethylene, tetrafluoroethylene n-perfluoroalkyl vinyl ether copolymer, tetrafluoroethylene-hexafluoropropylene copolymer, tetrafluoroethylene-ethylene copolymer, tetrafluoroethylene-hexafluoropropylene-perfluoroalkyl vinyl ether copolymer and tetrafluoroethylene-perfluoroalkoxyethylene copolymer. As the fluorine resin, the PTFE is preferable.

Since the ratio (development unit durable fluorine content F_{1000D}/initial fluorine content F₀) and the ratio (cleaning unit durable fluorine content F_{1000C}/initial fluorine content F₀) are easily adjusted in a desired range, the number average primary particle diameter of the fluorine-containing particles is preferably equal to or greater than 100 nm but equal to or less than 300 nm. The number average primary particle diameter of the fluorine-containing particles is equal to or greater than 100 nm, and thus it is possible to suppress the embedding of the fluorine-containing particles in the toner base particles. On the other hand, the number average primary particle diameter of the fluorine-containing particles is equal to or less than 300 nm, and thus it is possible to optimize the number of fluorine-containing particles released from the toner base particles.

When the fluorine-containing particles are fluorine resin particles, as a method for adjusting the fluorine resin particles, an emulsion polymerization method is preferable. Since the fluorine resin particles obtained by the emulsion polymerization method are nearly spherical, the fluorine resin particles are preferable as the external additive for the toner. As the fluorine resin particles, a commercially available product may be used. Examples of the commercially available product include: KTL-500F (made by Kitamura Limited., a number average primary particle diameter of 300 nm); Lubron (registered trademark) L2 (made by Daikin Industries, Ltd., a number average primary particle diameter of 300 nm); Lubron (registered trademark) L5 (made by Daikin Industries, Ltd., a number average primary particle diameter of 200 nm); Fluon Lubricant L170J (made by Asahi ICI Fluoropolymers Co., Ltd., a number average primary particle diameter of 100 nm); Fluon Lubricant L 172J (made by Asahi ICI Fluoropolymers Co., Ltd., a number average primary particle diameter of 0.1 μm); MP-1100 (made by Mitsui-Chemours Fluoroproducts Co., Ltd., a number average primary particle diameter of 200 nm); MP-1200 (made by Mitsui-Chemours Fluoroproducts Co., Ltd., a number average primary particle diameter of 300 nm) and TLP-10F-1 (made by Mitsui-Chemours Fluoroproducts Co., Ltd., a number average primary particle diameter of 200 nm).

Since the ratio (development unit durable fluorine content F_{1000D}/initial fluorine content F₀) and the ratio (cleaning unit durable fluorine content F_{1000C}/initial fluorine content F₀) are easily adjusted in a desired range, the content of the fluorine-containing particles before the predetermined printing is preferably equal to or greater than 0.1 parts by mass but equal to or less than 5.0 parts by mass in 100.0 parts by mass of the toner base particles, and more preferably equal to or greater than 0.3 parts by mass but equal to or less than 1.0 part by mass.

### (Silica Particles)

The silica particles provide fluidity to the toner particles. As the silica particles, silica particles which have been subjected to surface treatment for providing one or both of a positive charging property and hydrophobicity are preferable. Since the ratio (development unit durable silica content Si_{1000D}/initial silica content Si₀) and the ratio (cleaning unit durable silica content Si_{1000C}/initial silica content Si₀) are easily adjusted in a desired range, the number average primary particle diameter of the silica particles is preferably equal to or greater than 10 nm but equal to or less than 45 nm, and more preferably equal to or greater than 12 nm but equal to or less than 40 nm. The number average primary particle diameter of the silica particles is equal to or greater than 10 nm, and thus it is possible to suppress the embedding of the silica particles in the toner base particles. On the other hand, the number average primary particle diameter of the silica particles is equal to or less than 40 nm, and thus the silica particles are unlikely to be separated from the toner base particles.

Since the ratio (development unit durable silica content Si_{1000D}/initial silica content Si₀) and the ratio (cleaning unit durable silica content Si_{1000C}/initial silica content Si₀) are easily adjusted in a desired range, the content of the silica particles before the predetermined printing is preferably equal to or greater than 0.1 parts by mass but equal to or less than 5.0 parts by mass in 100.0 parts by mass of the toner base particles, more preferably equal to or greater than 0.5 parts by mass but equal to or less than 3.0 parts by mass and further preferably equal to or greater than 1.5 parts by mass but equal to or less than 2.5 parts by mass.

In order to balance the number of fluorine-containing particles adhered to the restriction blade or the image carrying member and the number of fluorine-containing particles scraped off by the silica particles, the ratio WSi/WF of the content WSi of the silica particles in 100.0 parts by mass of the toner base particles before the predetermined printing to the content WF of the fluorine-containing particles in 100.0 parts by mass of the toner base particles before the predetermined printing is preferably equal to or greater than 2.5 but equal to or less than 5.0, and more preferably equal to or greater than 2.5 but equal to or less than 3.5.

### (Other External Additive Particles)

Examples of the other external additive particles include particles of metal oxides (specifically, alumina, magnesium oxide, zinc oxide and the like), particles of organic acid compounds such as fatty acid metal salts (specifically, zinc stearate and the like) and resin particles. However, the external additive does not need to include resin particles other than the fluorine resin particles described above.

### <Toner Base Particles>

The toner base particles contain, for example, a binding resin as a main component. The toner base particles may further contain an internal additive (for example, at least one of a colorant, a mold release agent, a charge control agent and another additive) as necessary. Examples of a method for manufacturing the toner base particles include a pulverization method and an aggregation method, and the pulverization method is preferable.

### (Binding Resin)

In terms of providing the toner having an excellent low-temperature fixing property, the toner base particles preferably contain a thermoplastic resin as a binding resin, and more preferably contain a thermoplastic resin in a proportion of 85% by mass or more of the total binding resin. Examples of the thermoplastic resin include styrene resins, acrylic ester resins, olefin resins (for example, polyethylene resins and polypropylene resins), vinyl resins (for example, vinyl chloride resins, polyvinyl alcohol, vinyl ether resins and N-vinyl resins), polyester resins, polyamide resins and urethane resins. Copolymers of these resins, that is, copolymers in which any repeating unit is introduced into the resins described above (for example, styrene-acrylic ester resins and styrene-butadiene resins) can also be used as the binding resin.

The content of the binding resin in the toner base particles is preferably equal to or greater than 60% by mass but equal to or less than 95% by mass, and more preferably equal to or greater than 75% by mass but equal to or less than 90% by mass.

In terms of enhancing the low-temperature fixing property of the toner, as the binding resin, a polyester resin is preferable. The polyester resin is obtained by polycondensation of one or more polyhydric alcohols and one or more polycarboxylic acids. Examples of an alcohol for synthesizing the polyester resin include dihydric alcohols (for example, a diol compound and a bisphenol compound) and trihydric or higher alcohols. Examples of a carboxylic acid for synthesizing the polyester resin include divalent carboxylic acids and trivalent or higher carboxylic acids. Instead of the polycarboxylic acid, a polycarboxylic acid derivative capable of forming an ester bond by polycondensation (for example, an anhydride of a polycarboxylic acid and a polycarboxylic acid halide) may be used.

Examples of the diol compound include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol and polytetramethylene glycol.

Examples of the bisphenol compound include bisphenol A, hydrogenated bisphenol A, ethylene oxide adducts of bisphenol A (for example, polyoxyethylene (2,2)-2,2-bis(4-hydroxyphenyl)propane) and propylene oxide adducts of bisphenol A.

Examples of the trihydric or higher alcohol include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkylsuccinic acids (more specifically, n-butylsuccinic acid, isobutylsuccinic acid, n-octylsuccinic acid, n-dodecylsuccinic acid and isododecylsuccinic acid) and alkenylsuccinic acids (more specifically, n-butenylsuccinic acid, isobutenylsuccinic acid, n-octenylsuccinic acid, n-dodecenylsuccinic acid and isododecenylsuccinic acid).

Examples of the trivalent or higher carboxylic acid include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxylpropane, 1,2,4-cyclohexanetricarboxylic acid, tetra(methylenecarboxyl)methane, 1,2,7,8-octanetetracarboxylic acid, pyromellitic acid and empol trimer acid.

The polyester resin is preferably a condensation polymer of a bisphenol A ethylene oxide adduct, terephthalic acid and trimellitic anhydride. The polyester resin is more preferably a condensation polymer of polyoxyethylene (2,2)-2,2-bis(4-hydroxyphenyl)propane, terephthalic acid and trimellitic anhydride.

### (Colorant)

As the colorant, a known pigment or dye can be used according to the color of the toner. In terms of forming a high-quality image using the toner, the content of the colorant is preferably equal to or greater than 1 part by mass but equal to or less than 20 parts by mass in 100 parts by mass of the binding resin.

The toner base particles may contain a black colorant. Examples of the black colorant include carbon black. The black colorant may be a colorant which is toned to black using a yellow colorant, a magenta colorant and a cyan colorant.

The toner base particles may contain a color colorant. Examples of the color colorant include a yellow colorant, a magenta colorant and a cyan colorant.

As the yellow colorant, for example, one or more compounds selected from the group consisting of a condensed azo compound, an isoindolinone compound, an anthraquinone compound, an azo metal complex, a methine compound and an arylamide compound can be used. Examples of the yellow colorant include C. I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191 and 194), Naphthol Yellow S, Hansa Yellow G and C.I. Vat Yellow.

As the magenta colorant, for example, one or more compounds selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound and a perylene compound can be used. Examples of the magenta colorant include C. I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221 and 254).

As the cyan colorant, for example, one or more compounds selected from the group consisting of a copper phthalocyanine compound, an anthraquinone compound and a basic dye lake compound can be used. Examples of the cyan colorant include C. I. Pigment Blue (1, 7, 15, 15:1, 15:2, 15:3, 15:4, 60, 62 and 66), Phthalocyanine Blue, C. I. Bat Blue and C. I. Acid Blue.

### (Mold Release Agent)

The release agent is used, for example, to provide offset resistance to the toner. In terms of providing sufficient offset resistance to the toner, the content of the mold release agent is preferably equal to or greater than 1 part by mass but equal to or less than 20 parts by mass in 100 parts by mass of the binding resin.

Examples of the mold release agent include an aliphatic hydrocarbon wax, an oxide of an aliphatic hydrocarbon wax, a vegetable wax, an animal wax, a mineral wax, an ester wax containing a fatty acid ester as the main component and a wax in which a fatty acid ester is partially or completely deoxidized. Examples of the aliphatic hydrocarbon wax include low molecular weight polyethylene, low molecular weight polypropylene, a polyolefin copolymer, a polyolefin wax, a microcrystalline wax, a paraffin wax and Fischer-Tropsch wax. Examples of the oxide of an aliphatic hydrocarbon wax include an oxidized polyethylene wax and a block copolymer of an oxidized polyethylene wax. Examples of the vegetable wax include a candelilla wax, a carnauba wax, a wood wax, a jojoba wax and a rice wax. Examples of the animal wax include a beeswax, a lanolin and spermaceti. Examples of the mineral wax include ozokerite, ceresin, and petrolatum. Examples of the ester wax containing a fatty acid ester as the main component include a montan acid ester wax and a castor wax. Examples of the wax in which a fatty acid ester is partially or completely deoxidized include a deacidified carnauba wax. As the mold release agent, a carnauba wax is preferable.

When the toner base particles contain the mold release agent, a compatibilizer may be added to the toner base particles in order to improve the compatibility between the binding resin and the mold release agent.

### (Charge Control Agent)

The charge control agent is used, for example, to provide the toner which has excellent charging stability or an excellent charging rise property. The charging rise property of the toner is an index of whether the toner can be charged to a predetermined charging level in a short period of time. A positively charged charge control agent is contained into the toner base particles, and thus the cationic nature of the toner base particles can be strengthened.

Examples of the positively charged charge control agent include an azine compound, a direct dye, an acid dye, an alkoxylated amine, an alkylamide, a quaternary ammonium salt and a resin containing a quaternary ammonium cationic group. As the charge control agent, a quaternary ammonium salt is preferable.

In terms of obtaining the toner which has excellent charge stability, the content of the charge control agent is preferably equal to or greater than 0.1 parts by mass but equal to or less than 30 parts by mass in 100 parts by mass of the binding resin, and more preferably equal to or greater than 1 part by mass but equal to or less than 5 parts by mass.

### <Method for Manufacturing Toner>

The toner can be manufactured, for example, by a manufacturing method which includes a step of preparing the toner base particles and a step of external addition.

### (Step of Preparing Toner Base Particles)

In the step of preparing the toner base particles, the toner base particles are prepared, for example, by the aggregation method or the pulverization method.

The aggregation method includes, for example, an aggregation step and a coalescence step. In the aggregation step, fine particles containing the components of the toner base particles are aggregated in an aqueous medium to form aggregated particles. In the coalescence step, the components contained in the aggregated particles are coalesced in the aqueous medium to form the toner base particles.

The pulverization method will then be described. In the pulverization method, the toner base particles can be prepared relatively easily, and thus it is possible to reduce manufacturing costs. When the toner base particles are prepared by the pulverization method, the step of preparing the toner base particles includes, for example, a melt-kneading step and a pulverization step. The step of preparing the toner base particles may further include a mixing step before the melt-kneading step. The step of preparing the toner base particles may further include at least one of a fine pulverization step and a classification step.

In the mixing step, the binding resin and an internal additive which is added as necessary are mixed, and thus a mixture is obtained. In the melt-kneading step, toner materials are melted and kneaded, and thus a melt-kneaded product is obtained. As the toner materials, for example, the mixture obtained in the mixing step is used. In the pulverization step, the melt-kneaded product obtained is cooled to, for example, room temperature (25°) and is then pulverized, and thus a pulverized product is obtained. When the diameter of the pulverized product obtained in the pulverization step needs to be decreased, a step (fine pulverization step) for further pulverizing the pulverized product may be performed. When the particle diameter of the pulverized product is made uniform, a step of classifying the pulverized product obtained (classification step) may be performed. By the steps described above, the toner base particles which are the pulverized product are obtained.

### (Step of External Addition)

In the step of external addition, the external additive which includes the fluorine-containing particles and the silica particles is adhered to the surfaces of the toner base particles, and thus the toner particles are obtained. A method for adhering the external additive to the surfaces of the toner base particles is not particularly limited, and examples of the method include a method of stirring the toner base particles and the external additive with a mixer or the like.

When the external additive is adhered by stirring, the toner base particles and the external additive particles are fixed not chemically but physically without reacting with each other. The degree of fixation of the toner base particles and the external additive particles can be adjusted by stirring conditions (more specifically, a stirring time, a stirring rotation speed and the like), the particle diameter of the external additive particles, the shape of the external additive particles, the state of the surface of the external additive particles and the like. Hence, the stirring conditions are changed, and thus development unit durable silica content Si_{1000D}/initial silica content Si₀ and development unit durable fluorine content F_{1000D}/initial fluorine content F₀ can be adjusted as necessary.

For example, as the stirring time during which the toner base particles and the silica particles are stirred is increased, the silica particles are sufficiently fixed to the surfaces of the toner base particles, and thus the number of silica particles separated from the toner base particles in the development unit is reduced. Consequently, there is a tendency that the development unit durable silica content Si_{1000D} is lowered, and development unit durable silica content Si_{1000D}/initial silica content Si₀ is also lowered. Moreover, as the stirring time during which the toner base particles and the fluorine-containing particles are stirred is increased, the fluorine-containing particles are sufficiently fixed to the surfaces of the toner base particles, and thus the number of fluorine-containing particles separated from the toner base particles in the development unit is reduced. Consequently, there is a tendency that the development unit durable fluorine content F_{1000D} is lowered, and development unit durable fluorine content F_{1000D}/initial fluorine content F₀ is also lowered.

The fluorine-containing particles and the silica particles may be simultaneously added and stirred with respect to the toner base particles. One of the fluorine-containing particles and the silica particles may be added and stirred with respect to the toner base particles, and the other may be thereafter added and further stirred. When the fluorine-containing particles and the silica particles are added at different timings, the degree of fixation of the silica particles to the toner base particles and the degree of fixation of the fluorine-containing particles thereto can be adjusted independently.

### Second Embodiment: Image Forming Apparatus

The second embodiment of the present disclosure relates to an image forming apparatus. The image forming apparatus 1 which is an example of the image forming apparatus of the present disclosure will be described below with reference back to FIGS. 1 to 3. In the drawings, the same reference symbols indicate the same parts or the corresponding parts. The dimensions of lengths, widths, thicknesses, depths and the like are changed as necessary for clarity and simplification of the drawings, and do not represent the actual dimensions.

As shown in FIG. 1, the image forming apparatus 1 includes a paper feed unit 10, a conveyance unit 11, an image formation unit 12, a fixing unit 13, an ejection unit 14 and a control unit 15.

The paper feed unit 10 includes a paper feed cassette 30 and a paper feed roller group 31. The paper feed cassette 30 can store a plurality of recording media P. The paper feed roller group 31 feeds the recording media P stored in the paper feed cassette 30 to conveyance unit 11 one by one. The recording medium P is made of, for example, paper or synthetic resin.

The conveyance unit 11 extends from the paper feed unit 10 to the ejection unit 14. The conveyance unit 11 conveys the recording medium P from the paper feed unit 10 to the ejection unit 14 via the image formation unit 12 and the fixing unit 13.

The image formation unit 12 includes an exposure unit 20, a charging unit 21, a development unit 22, an image carrying member 23, a cleaning unit 24 and a transfer unit 25. The charging unit 21, the development unit 22, the transfer unit 25 and the cleaning unit 24 are arranged in this order along the circumferential surface of the image carrying member 23 from an upstream side in the rotation direction R (clockwise direction in FIG. 1) of the image carrying member 23.

The charging unit 21 uniformly charges the image carrying member 23 to a predetermined polarity.

The exposure unit 20 applies (exposes) light to the surface 23a of the charged image carrying member 23. The exposure unit 20 exposes the surface 23a of the image carrying member 23 based on image data input to the image forming apparatus 1. Consequently, an electrostatic latent image is formed on the surface 23a of the image carrying member 23.

The development unit 22 stores the toner T. The development unit 22 supplies the toner T to the electrostatic latent image formed on the surface 23a of the image carrying member 23 to develop the electrostatic latent image into a toner image. The details of the development unit 22 will be described later.

The toner T is the toner described in the first embodiment. Hence, the image forming apparatus 1 can form images which have a high image density, a small number of thin layer streaks and a small amount of fogging due to the same reason as described in the first embodiment. In the second embodiment, predetermined printing is performed using the image forming apparatus 1 of the second embodiment.

The image carrying member 23 carries the toner image on the surface 23a. The image carrying member 23 is, for example, a photosensitive drum.

The transfer unit 25 is arranged opposite the image carrying member 23, and transfers the toner image on the image carrying member 23 to the recording medium P.

The cleaning unit 24 collects the toner T left on the surface 23a of the image carrying member 23 after the transfer from the surface 23a of the image carrying member 23. The details of the cleaning unit 24 will be described later.

The fixing unit 13 includes a heating unit 40 and a pressure unit 41. The heating unit 40 and the pressure unit 41 are arranged opposite each other. The pressure unit 41 presses the heating unit 40 to from a fixing nip. The recording medium P to which the toner image has been transferred is passed through the fixing nip to be heated and pressurized. Consequently, the toner T is fixed to the recording medium P. The recording medium P is conveyed by the conveyance unit 11 from the fixing unit 13 to the ejection unit 14.

The ejection unit 14 includes an ejection roller pair 60 and an ejection tray 61. The ejection roller pair 60 ejects the recording medium P to the ejection tray 61.

The control unit 15 controls the operations of the units included in the image forming apparatus 1. An example of the control unit 15 is a processor such as a CPU (Central Processing Unit). The control unit 15 comprehensively controls the operations of the image forming apparatus 1 to realize various types of functions.

The development unit 22 will then be described in detail with reference to FIG. 2. As already described, the development unit 22 includes a storage frame 210, a supply roller 220, a development roller 230 and a restriction blade 240. The lengths of the supply roller 220 and the development roller 230 in an axial direction (direction orthogonal to the plane of FIG. 2) are substantially the same as the length of the image carrying member 23.

The storage frame 210 stores the toner T therein. The storage frame 210 includes the supply roller 220, the development roller 230 and the restriction blade 240 therein. The storage frame 210 includes an opening portion 211, and the opening portion 211 is arranged opposite the image carrying member 23. The opening portion 211 exposes a part of the development roller 230 to the outside of the storage frame 210.

The supply roller 220 is supported rotatably in a direction indicated by an arrow in FIG. 2 (counterclockwise direction). The supply roller 220 carries the toner T stored in the storage frame 210 on the surface (circumferential surface) of the supply roller 220. A nip N1 is provided between the development roller 230 and the supply roller 220. In the nip N1, the supply roller 220 supplies the toner T carried on the surface to the development roller 230. In the nip N1, the toner T on the supply roller 220 makes contact with the development roller 230, and thus the toner T is frictionally charged.

The development roller 230 is supported rotatably in a direction indicated by an arrow in FIG. 2 (counterclockwise direction). The development roller 230 is arranged opposite the supply roller 220. The development roller 230 is arranged opposite the image carrying member 23 via the opening portion 211 of the storage frame 210. The development roller 230 carries the toner T supplied from the supply roller 220 on the surface (circumferential surface) 230a thereof. Specifically, the toner T is carried on the surface 230a of the development roller 230 by a mirror image force acting between the development roller 230 and the toner T.

The development roller 230 includes a conductive support member 231, an elastic layer 232 and a coat layer 233. The elastic layer 232 is provided on the conductive support member 231 (specifically, on the outer circumferential surface of the conductive support member 231). The elastic layer 232 is formed of, for example, silicone rubber. The coat layer 233 is provided on the elastic layer 232 (specifically, on the outer circumferential surface of the elastic layer 232). The coat layer is formed of, for example, urethane.

The restriction blade 240 is in the shape of a plate. One end 241 of the restriction blade 240 is fixed to the storage frame 210, and the other end 242 is a free end. The restriction blade 240 is bent to the opposite side to the side of the development roller 230 in the vicinity of an outer edge on the side of the other end 242 (free end). The restriction blade 240 is formed of, for example, stainless steel (SUS).

The restriction blade 240 can be flexibly deformed such that the side of the other end 242 approaches the development roller 230. The development roller 230 includes one or more magnet portions (not shown) therein. The restriction blade 240 is magnetic. The side of the other end 242 of the restriction blade 240 which is magnetic is biased toward the development roller 230 by a magnetic force generated by the magnet portions of the development roller 230. In this way, a nip N2 is provided between the restriction blade 240 and the surface 230a of the development roller 230. In the nip N2, the restriction blade 240 makes contact with (specifically, surface contact with) the toner layer formed on the surface 230a of the development roller 230 at a predetermined pressure to restrict the thickness of the toner layer. The pressure (restriction pressure) of the restriction blade 240 to the surface 230a of the development roller 230 is preferably equal to or greater than 15 N/m and equal to or less than 40 N/m so that the thickness of the toner layer is restricted within a desired range. In the nip N2, the toner T on the development roller 230 makes contact with the restriction blade 240, and thus the toner T is further frictionally charged.

A development bias is applied to the development roller 230, and thus the toner T contained in the toner layer is supplied from the development roller 230 to the electrostatic latent image formed on the surface 23a of the image carrying member 23 through the opening portion 211. The details of the development unit 22 has been described above with reference to FIG. 2.

The cleaning unit 24 will then be described in detail with reference to FIG. 3. As already described, the cleaning unit 24 includes a cleaning housing 50 and a cleaning member 51.

The cleaning member 51 is attached to the inside of the cleaning housing 50. The cleaning member 51 is in the shape of a plate which extends in the direction of the rotation axis of the image carrying member 23. The cleaning member 51 is, for example, a cleaning blade. The cleaning member 51 is formed of, for example, rubber (more specifically, urethane rubber).

The cleaning member 51 is pressed against the surface 23a of the image carrying member 23 on the downstream side of the transfer unit 25 in the rotation direction R of the image carrying member 23. The cleaning member 51 is also pressed against the surface 23a of the image carrying member 23 from above the rotation axis of the image carrying member 23. A direction D extending from the base end portion 51b of the cleaning member 51 toward a tip end portion 51a is a direction which extends downward from above the rotation axis of the image carrying member 23, and the tip end portion 51a is located above the rotation axis of the image carrying member 23 to make contact with the surface 23a of the image carrying member 23. The direction D extending from the base end portion 51b of the cleaning member 51 toward the tip end portion 51a is directed in a direction opposite to the rotation direction R of the image carrying member 23 at a contact point CP between the tip end portion 51a of the cleaning member 51 and the surface 23a of the image carrying member 23. In other words, the tip end portion 51a of the cleaning member 51 is directed in a so-called counter direction relative to the rotation direction R of the image carrying member 23. In the configuration as described above, the cleaning member 51 can efficiently remove the toner T left on the surface 23a of the image carrying member 23 after the transfer. In order to efficiently remove the toner T, the linear pressure of the cleaning member 51 to the image carrying member 23 is preferably equal to or greater than 10 N/m but equal to or less than 30 N/m.

The cleaning housing 50 has a depth in the direction of the rotation axis of the image carrying member 23. The cleaning housing 50 collects the toner T removed by the cleaning member 51 thereinto. The details of the cleaning unit 24 has been described above with reference to FIG. 3.

As described above, as the example of the image forming apparatus of the second embodiment, the image forming apparatus 1 shown in FIG. 1 has been described. However, the image forming apparatus of the second embodiment is not limited to the image forming apparatus 1 described above, and for example, the following respects can be changed.

For example, although in the second embodiment described above, the image forming apparatus 1 is a device which records an image using the toner of a single color, the present disclosure is not limited to this configuration. The image forming apparatus 1 may be a device which records a color image using the toner of multiple colors.

Although in the second embodiment described above, the cleaning unit 24 includes the cleaning member 51, the present disclosure is not limited to this configuration. The cleaning unit 24 may further include a rubbing roller in addition to the cleaning member 51. The cleaning unit 24 may include a rubbing roller without including the cleaning member 51. The rubbing roller collects the toner T from the surface 23a of the image carrying member 23, and also polishes the surface 23a of the image carrying member 23 with the toner adhered to the surface of the rubbing roller.

Although in the second embodiment described above, the direction D extending from the base end portion 51b of the cleaning member 51 toward the tip end portion 51a is the direction which extends downward from above the rotation axis of the image carrying member 23, and the tip end portion 51a is located above the rotation axis of the image carrying member 23 to make contact with the surface 23a of the image carrying member 23, the present disclosure is not limited to this configuration. The direction D extending from the base end portion 51b of the cleaning member 51 toward the tip end portion 51a may be a direction which extends upward from below the rotation axis of the image carrying member 23, and the tip end portion 51a may be located below the rotation axis of the image carrying member 23 to make contact with the surface 23a of the image carrying member 23. When a counter contact is made in the configuration described above, the rotation direction of the image carrying member 23 is a direction opposite to the rotation direction R (counterclockwise direction in FIG. 1).

### EXAMPLES

Although Examples in the present disclosure will be described below, the present disclosure is not limited to the scope of Examples at all. A method for measuring physical property values will first be described.

### [Number Average Primary Particle Diameter]

The number average primary particle diameter of the external additive particles was determined from a particle projection image captured using a scanning electron microscope (“JSM-7600F” made by JEOL Ltd.). Specifically, the external additive particles were observed using the scanning electron microscope, and the number average of the circle equivalent diameters (Heywood diameter: diameter of a circle having the same area as the projected area of a primary particle) of 100 external additive particles was used as the number average primary particle diameter.

### [Silica Particles]

Commercially available silica particles used as the external additive are shown below,
Silica particles (TG7120): hydrophobic silica particles (“TG7120” made by Cabot Specialty Chemicals, Inc., a number average primary particle diameter of 20 nm)
Silica particles (REA200): hydrophobic silica particles (“REA200” made by Nippon Aerosil Co., Ltd., a number average primary particle diameter of 12 nm)
Silica particles (NA50H): hydrophobic silica particles (“NA50H” made by Nippon Aerosil Co., Ltd., a number average primary particle diameter of 40 nm)
Silica particles (H3050VP): hydrophobic silica particles (“H3050VP” made by Wacker Chemie AG, a number average primary particle diameter of 8 nm)
Silica particles (H05TA): hydrophobic silica particles (“H05TA” made by Wacker Chemie AG, a number average primary particle diameter of 50 nm)

### [Fluorine-Containing Particles]

By the following method, the fluorine-containing particles used as the external additive were prepared. The details of the fluorine-containing particles are shown in Table 1 below. The “particle diameter” used in Table 1 indicates the number average primary particle diameter.

Table 1 is as follows.

TABLE 1

| Fluorine- | | | |
|---|---|---|---|
| containing | Particle diameter | Stirring speed X | Polymerization time Y |
| particles | [nm] | [rpm] | [minute] |
| F-A | 200 | 250 | 50 |
| F-B | 100 | 250 | 40 |
| F-C | 300 | 200 | 60 |
| F-D | 60 | 250 | 35 |
| F-E | 400 | 200 | 80 |

### <Preparation of Fluorine-Containing Particles (F-A)>

An autoclave including a stainless steel anchor-type stirring blade and a temperature control jacket was used as a reaction vessel. 3580 mL of deionized water, 3.58 g of ammonium perfluorooctanoate and paraffin wax (“Paraffin Wax-130” made by Nippon Seiro Co., Ltd., 94.1 g) were put into the reaction vessel. After the inside of the reaction vessel was replaced with nitrogen gas and tetrafluoroethylene (TFE), TFE was further added into the reaction vessel under pressure, while the contents of the reaction vessel were being stirred at a stirring speed of 250 rpm (hereinafter, the stirring speed X), the reaction vessel was heated such that the temperature of the contents of the reaction vessel reached 80° C. and this temperature was held. While an aqueous ammonium persulfate solution (concentration: 0.067% by mass) and an aqueous disuccinic acid peroxide solution (concentration: 1.61% by mass) were being added under pressure, TFE was continuously supplied such that the pressure inside the reaction vessel was kept constant (0.78 MPa). In this way, a polymerization reaction was performed for 50 minutes (hereinafter, the polymerization time Y). In the polymerization reaction, the amount of aqueous ammonium persulfate solution added under pressure was 20 mL, the amount of aqueous disuccinic acid peroxide solution added under pressure was 20 mL and the amount of TFE added under pressure was 1735 g. After the elapse of the polymerization time Y, the supply of TFE and the stirring of the contents of the reaction vessel were stopped, and thus the polymerization reaction was completed. 100 mL of an aqueous solution of ammonium hydroperfluorononanoate (concentration: 10% by mass) was put into a latex-like reaction product obtained by the polymerization reaction. Then, hot water was put into the reaction product to adjust the temperature to 50° C. Then, 10 mL of nitric acid (concentration: 60% by mass) was added to the reaction product, and simultaneously, the reaction product was stirred at a stirring speed of 250 rpm. Consequently, fluorine-containing particles (F-A) began to precipitate from the reaction product. Then, the reaction product was stirred for 1 hour to sufficiently separate the fluorine-containing particles (F-A) from a solvent. Then, the solvent was removed from the fluorine-containing particles (F-A) and was dried, and thus the fluorine-containing particles (F-A) having the number average primary particle diameter indicated in Table 1 were obtained.

### <Preparation of Fluorine-Containing Particles (F-B) to (F-E)>

Fluorine-containing particles (F-B) to (F-E) were prepared by the same method as the preparation of the fluorine-containing particles (F-A) except that the stirring speed X and the polymerization time Y were changed to values shown in Table 1.

### [Toner]

By the following method, toners used in Examples and Comparative Examples were prepared. The details of the toners are shown in Table 2.

Table 2 is as follows.

TABLE 2

| | Silica particles | | Fluorine-containing particles | |
|---|---|---|---|---|
| | | Number | | Number |
| Toner | Type | [mass parts] | Type | [mass parts] |
| T-A1 | TG7120 | 2.0 | F-A | 0.5 |
| T-A2 | REA200 | 1.5 | F-B | 0.3 |
| T-A3 | NA50H | 2.5 | F-C | 1.0 |
| T-B1 | TG7120 | 2.0 | F-D | 0.5 |
| T-B2 | TG7120 | 2.0 | F-E | 0.5 |
| T-B3 | H3050VP | 2.0 | F-A | 0.5 |
| T-B4 | H05TA | 2.0 | F-A | 0.5 |

### <Preparation of Toner (T-A1)>

### (Preparation of Polyester Resin)

By the following method, a polyester resin used as the binding resin of the toner was prepared. 1.0 mole of polyoxyethylene (2.2)-2,2-bis(4-hydroxyphenyl) propane, 4.5 moles of terephthalic acid, 0.5 moles of anhydrous trimellitic acid and 4 g of dibutyltin oxide were put into a reaction vessel. The contents of the reaction vessel were reacted at 230° C. for 8 hours under a nitrogen atmosphere. Then, the unreacted raw materials in the reaction vessel were distilled off under reduced pressure of 8.3 kPa. The reaction product obtained was washed and then dried. In this way, the polyester resin having a softening point of 120° C. was obtained.

### (Preparation of Toner Base Particles)

100 parts by mass of the above polyester resin serving as the binding resin, 5 parts by mass of carbon black (“REGAL (registered trademark) 330R” made by Cabot Specialty Chemicals, Inc.) serving as a colorant, 10 parts by mass of carnauba wax (“Carnauba No. 1” made by S. KATO & CO.) serving as a mold release agent and 3 parts by mass of a quaternary ammonium salt compound (“FCA210PS” made by Fujikura Kasei Co., Ltd.) serving as a charge control agent were mixed using an FM mixer (“FM20B” made by Nippon Coke & Engineering Co., Ltd.). The resulting mixture was melted and kneaded at 150° C. using a twin-screw extruder (“TEM45” made by Toshiba Machine Co., Ltd.). The resulting kneaded product was cooled. The cooled kneaded product was coarsely pulverized using an impact screen type fine pulverizer (“Feather Mill (registered trademark) FM-2S 350×600 type” made by Hosokawa Micron Corporation). The resulting coarsely pulverized product was finely pulverized using a supersonic jet pulverizer (“Jet Mill IDS-2” made by Nippon Pneumatic Mfg. Co., Ltd.). The resulting finely pulverized product was classified using a classifier (“Elbow Jet EJ-LABO type” made by Nittetsu Mining Co., Ltd.). In this way, toner base particles were obtained. The volume median diameter (D₅₀) of the toner base particles was 8 μm.

### (External Addition)

100.0 parts by mass of the toner base particles, the silica particles and the fluorine-containing particles were put into a container. The types and numbers of silica particles put thereinto and the types and numbers of fluorine-containing particles put thereinto were set as shown in Table 2. The contents of the container were mixed using an FM mixer (“FM-10B” made by Nippon Coke & Engineering Co., Ltd.) at a rotation speed of 3500 rpm for 5 minutes. In this way, the external additive was adhered to the surfaces of the toner base particles. Consequently, a toner (T-A1) was obtained.

### <Preparation of Toners (T-A2), (T-A3) and (T-B1) to (T-B4)>

Toners (T-A2), (T-A3) and (T-B1) to (T-B4) were prepared by the same method as the preparation of the toner (T-A1) except that in external addition, the types and numbers of silica particles put thereinto and the types and numbers of fluorine-containing particles put thereinto were set as shown in Table 2.

### [Predetermined Printing]

By the following method, predetermined printing was performed on the toners. A modified monochrome printer (“PA2000” made by Kyocera Document Solutions, Inc.) in which a cleaning unit was attached was used as a test machine for the predetermined printing. The test machine included a toner container, an image carrying member, a development unit having a restriction blade and a cleaning unit having a cleaning blade. The toner (any one of the toners (T-A1) to (T-A3) and (T-B1) to (T-B4)) to be measured was filled in the toner container of the test machine. The standard test page image defined in ISO 19752 was printed using the test machine on 1000 sheets of recording media (A4 size plain paper) under the following printing conditions.

### <Printing Conditions>

Material of development roller: silicone rubber coated with urethane
Material of restriction blade: SUS
Restriction pressure of restriction blade: 40 N/m
Material of cleaning blade: urethane rubber
Linear pressure of cleaning blade: 20 N/m
Contact direction of cleaning blade: counter direction
Printing environment: temperature of 23° C. and relative humidity of 50% RH
Printing mode: intermittent printing which repeats printing of two sheets and stop of printing for 400 seconds
Printing speed: 20 pages/minute when recording medium is conveyed in the length direction thereof

### [Measurement]

<Measurement of Initial Silica Content Si₀ and Initial Fluorine Content F₀>

The toner before the predetermined printing described above was performed (that is, the toner before being filled in the toner container of the test machine) was assumed to be a measurement target. Fluorescent X-ray analysis below was performed on the measurement target, and thus the content of the silica particles in the toner particles and the content of the fluorine-containing particles in the toner particles were determined. The content of the silica particles in the toner particles was assumed to be the initial silica content Si₀. The content of the fluorine-containing particles in the toner particles was assumed to be the initial fluorine content F₀. The initial silica content Si₀ and the initial fluorine content F₀ are shown in Table 3 below.

### <Fluorescent X-Ray Analysis>

1.5 g of the measurement target was press-molded under conditions of a pressure of 20 MPa and a pressurization time of 3 seconds, and thus a cylindrical pellet having a diameter of 30 mm was prepared. The obtained pellet was subjected to fluorescent X-ray analysis under the following conditions, and a fluorescent X-ray spectrum (horizontal axis: energy, vertical axis: intensity (number of photons)) including peaks derived from the measurement target (Si and F) was obtained. A previously prepared calibration curve was used, and thus the X-ray intensity of the peak derived from the measurement target Si in the fluorescent X-ray spectrum obtained was converted to the content of the silica particles in the toner particles (unit: mass %). A previously prepared calibration curve was used, and thus the X-ray intensity of the peak derived from the measurement target F in the fluorescent X-ray spectrum was converted to the content of the fluorine-containing particles in the toner particles (unit: mass %). The calibration curves were produced using samples in which the content of the silica particles in the toner particles and the content of the fluorine-containing particles in the toner particles were known.

### (Conditions of Fluorescent X-Ray Analysis)

Analyzer: scanning fluorescence X-ray analyzer (“ZSX” made by Rigaku Corporation)
X-ray tube (X-ray source): Rh (rhodium)
Excitation conditions: tube voltage of 50 kV and tube current of 50 mA
Measurement region (X-ray application range): diameter of 30 mm
Measurement target: Si, F
   <Measurement of Development Unit Durable Silica Content Si_{1000D} and Development Unit Durable Fluorine Content F_{1000D}>

After the predetermined printing described above was performed, the toner was taken out from the interior of the development unit included in the test machine, and the toner was assumed to be a measurement target. The fluorescent X-ray analysis described above was performed on the measurement target, and thus the content of the silica particles in the toner particles and the content of the fluorine-containing particles in the toner particles were determined. The content of the silica particles in the toner particles was assumed to be a development unit durable silica content Si_{1000D}. The content of the fluorine-containing particles in the toner particles was assumed to be a development unit durable fluorine content F_{1000D}. The development unit durable silica content Si_{1000D} and the development unit durable fluorine content F_{1000D} are shown in Table 3. The ratio (development unit durable silica content Si_{1000D}/initial silica content Si₀) determined from a formula “ratio Si_{1000D}/Si₀=development unit durable silica content Si_{1000D}/initial silica content Si₀” is shown in Table 3. The ratio (development unit durable fluorine content F_{1000D}/initial fluorine content F₀) determined from a formula “ratio F_{1000D}/F₀=development unit durable fluorine content F_{1000D}/initial fluorine content F₀” is shown in Table 3.

<Measurement of Cleaning Unit Durable Silica Content Si_{1000C} And Cleaning Unit Durable Fluorine Content F_{1000C}>

After the predetermined printing described above was performed, the toner was taken out from the interior of the cleaning unit included in the test machine, and the toner was assumed to be a measurement target. The fluorescent X-ray analysis described above was performed on the measurement target, and thus the content of the silica particles in the toner particles and the content of the fluorine-containing particles in the toner particles were determined. The content of the silica particles in the toner particles was assumed to be a cleaning unit durable silica content Si_{1000C}. The content of the fluorine-containing particles in the toner particles was assumed to be a cleaning unit durable fluorine content F_{1000C}. The cleaning unit durable silica content Si_{1000C} and the cleaning unit durable fluorine content F_{1000C} are shown in Table 4. For ease of understanding, the initial silica content Si₀ and the initial fluorine content F₀ shown in Table 3 are shown again in Table 4. The ratio (cleaning unit durable silica content Si_{1000C}/initial silica content Si₀) determined from a formula “ratio Si_{1000C}/Si₀=cleaning unit durable silica content Si_{1000C}/initial silica content Si₀” is shown in Table 4. The ratio (cleaning unit durable fluorine content F_{1000C}/initial fluorine content F₀) determined from a formula “ratio F_{1000C}/F₀=cleaning unit durable fluorine content F_{1000C}/initial fluorine content F₀” is shown in Table 4.

Table 3 is as follows.

TABLE 3

| | Silica particles | | | | Fluorine-containing particles | | | |
|---|---|---|---|---|---|---|---|---|
| | | Si₀ | Si_{1000D} | | | F₀ | F_{1000D} | |
| Toner | Type | [mass %] | [mass %] | Si_{1000D}/Si₀ | Type | [mass %] | [mass %] | F_{1000D}/F₀ |
| T-A1 | TG7120 | 2.0 | 1.4 | 0.7 | F-A | 0.5 | 0.6 | 1.2 |
| T-A2 | REA200 | 1.5 | 0.8 | 0.5 | F-B | 0.3 | 0.3 | 1.0 |
| T-A3 | NA50H | 2.5 | 2.5 | 1.0 | F-C | 1.0 | 1.5 | 1.5 |
| T-B1 | TG7120 | 2.0 | 1.4 | 0.7 | F-D | 0.5 | 0.3 | 0.6 |
| T-B2 | TG7120 | 2.0 | 1.4 | 0.7 | F-E | 0.5 | 0.8 | 1.6 |
| T-B3 | H3050VP | 2.0 | 0.8 | 0.4 | F-A | 0.5 | 0.6 | 1.2 |
| T-B4 | H05TA | 2.0 | 2.2 | 1.1 | F-A | 0.5 | 0.6 | 1.2 |

Table 4 is as follows.

TABLE 4

| | Silica particles | | | | Fluorine-containing particles | | | |
|---|---|---|---|---|---|---|---|---|
| | | Si₀ | Si_{1000C} | | | F₀ | F_{1000C} | |
| Toner | Type | [mass %] | [mass %] | Si_{1000C}/Si₀ | Type | [mass %] | [mass %] | F_{1000C}/F₀ |
| T-A1 | TG7120 | 2.0 | 1.6 | 0.8 | F-A | 0.5 | 1.2 | 2.3 |
| T-A2 | REA200 | 1.5 | 1.1 | 0.7 | F-B | 0.3 | 0.6 | 2.0 |
| T-A3 | NA50H | 2.5 | 2.3 | 0.9 | F-C | 1.0 | 2.5 | 2.5 |
| T-B1 | TG7120 | 2.0 | 1.6 | 0.8 | F-D | 0.5 | 0.9 | 1.8 |
| T-B2 | TG7120 | 2.0 | 1.6 | 0.8 | F-E | 0.5 | 1.3 | 2.6 |
| T-B3 | H3050VP | 2.0 | 1.2 | 0.6 | F-A | 0.5 | 1.2 | 2.3 |
| T-B4 | H05TA | 2.0 | 2.0 | 1.0 | F-A | 0.5 | 1.2 | 2.3 |

### [Evaluations]

By the following method, images which were printed using the toners (T-A1) to (T-A3) and (T-B1) to (T-B4) were evaluated for a thin layer streak, an image density, fogging and a blank area. The results of the evaluations are shown in Table 5 below.

### <Printing>

In the predetermined printing described above, printing was performed on 1000 sheets of recording media (first to 1000th sheets), and then printing was further performed on 500 sheets of recording media (1001st to 1500th sheets) by the same method as the predetermined printing.

### <Thin Layer Streak>

The image printed on the 1500th sheet was visually observed, and thus whether a thin layer streak was generated was determined. The thin layer streak was determined according to the following criterion.

### (Criterion for Thin Layer Streak)

A (satisfactory): no thin layer streak was confirmed
B (unsatisfactory): a thin layer streak was confirmed

### <Image Density>

The reflection density (ID) of a print portion of the image printed on the 1500th sheet was measured using a white light photometer (“TC-6DX” made by Tokyo Denshoku Co., Ltd.). The image density was determined according to the following criterion.

### (Criterion for Image Density)

A (satisfactory): ID was equal to or greater than 1.20
B (unsatisfactory): ID was less than 1.20

### <Fogging>

The reflection density A of a non-print portion (white portion) of the image printed on the 1500th sheet was measured using the white light photometer (“TC-6DX” made by Tokyo Denshoku Co., Ltd.). The reflection density B of an unprinted recording medium was measured using the white light photometer (“TC-6DX” made by Tokyo Denshoku Co., Ltd.). A formula “fogging density=reflection density A=reflection density B” was used to calculate a fogging density (FD). The fogging was determined according to the following criterion.

### (Criterion for Fogging)

A (satisfactory): FD was equal to or less than 0.010
B (unsatisfactory): FD was greater than 0.010

### <Blank Area>

The image printed on the 1500th sheet was visually observed, and thus whether a blank area was generated was determined. The blank area was determined according to the following criterion.

### (Criterion for Blank Area)

A (satisfactory): no blank area was confirmed
B (unsatisfactory): a blank area was confirmed

When image failures (a thin layer streak, an image density failure, fogging and a blank area) were confirmed on images printed before the 1500th sheet, the details of the image failures were described in remarks in Table 5.

Table 5 is as follows. “EX1” represents Example 1. “EX2” represents Example 2. “EX3” represents Example 3. “CEX1” represents Comparative Example 1. “CEX2” represents Comparative Example 2. “CEX3” represents Comparative Example 3. “CEX4” represents Comparative Example 4.

TABLE 5

| | | Evaluations (1500th sheet) | | | | |
|---|---|---|---|---|---|---|
| | Toner | Thin layer streak | ID | FD | Blank area | Notes |
| EX1 | T-A1 | A | 1.35 | 0.002 | A | — |
| EX2 | T-A2 | A | 1.21 | 0.001 | A | — |
| EX3 | T-A3 | A | 1.50 | 0.008 | A | — |
| CEX1 | T-B1 | B | 1.05 | 0.001 | B | Thin layer streak was generated on |
| | | | | | | 1100th sheet |
| | | | | | | Blank area was generated on |
| | | | | | | 1100th sheet |
| CEX2 | T-B2 | A | 1.75 | 0.020 | A | Fogging occurred on 1300th |
| | | | | | | sheet (FD = 0.012) |
| CEX3 | T-B3 | B | 0.85 | 0.000 | A | Thin layer streak was generated on |
| | | | | | | 1200th sheet |
| | | | | | | Image density failure occurred on |
| | | | | | | 1100th sheet (ID = 1.10) |
| CEX4 | T-B4 | B | 1.20 | 0.001 | B | Thin layer streak was generated on |
| | | | | | | 1400th sheet |
| | | | | | | Blank area was generated on |
| | | | | | | 1400th sheet |

Each of the toners (T-A1) to (T-A3) included toner particles, and the toner particles included toner base particles and an external additive adhered to the surfaces of the toner base particles. The external additive included silica particles and fluorine-containing particles. The toners satisfied a formula (1) “0.5≤Si_{1000D}/Si₀≤1.0”. The toners satisfied a formula (2) “1.0≤F_{1000D}/F₀≤1.5”. The evaluations of the toners (T-A1) to (T-A3) for the thin layer streak, the image density and the fogging were satisfactory.

On the other hand, for the toner (T-B1), the ratio (development unit durable fluorine content F_{1000D}/initial fluorine content F₀) was less than 1.0, and the formula (2) “1.0≤F_{1000D}/F₀≤1.5” was not satisfied. The evaluations of the toner (T-B1) for the thin layer streak and the image density were unsatisfactory.

For the toner (T-B2), the ratio (development unit durable fluorine content F_{1000D}/initial fluorine content F₀) was greater than 1.5, and the formula (2) “1.0≤F_{1000D}/F₀≤1.5” was not satisfied. The evaluation of the toner (T-B2) for the fogging was unsatisfactory.

For the toner (T-B3), the ratio (development unit durable silica content Si_{1000D}/initial silica content Si₀) was less than 0.5, and the formula (1) “0.5≤Si_{1000D}/Si₀≤1.0” was not satisfied. The evaluations of the toner (T-B3) for the thin layer streak and the image density were unsatisfactory.

For the toner (T-B4), the ratio (development unit durable silica content Si_{1000D}/initial silica content Si₀) was greater than 1.0, and the formula (1) “0.5≤Si_{1000D}/Si₀≤1.0” was not satisfied. The evaluation of the toner (T-B4) for the thin layer streak was unsatisfactory.

Therefore, the toners of the present disclosure including the toners (T-A1) to (T-A3) are determined to be able to form images which have a high image density, a small number of thin layer streaks and a small amount of fogging.

Furthermore, each of the toners (T-A1) to (T-A3) satisfied a formula (3) “0.7 Si_{1000C}/Si₀≤0.9” and a formula (4) “2.0≤F_{1000C}/F₀≤2.5”. The evaluations of the toners (T-A1) to (T-A3) which satisfied the formulae (3) and (4) in addition to the formulae (1) and (2) for the blank area in addition to the thin layer streak, the image density and the fogging were satisfactory.

The non-magnetic one-component toner and the image forming apparatus according to the present disclosure can form, even when a large number of sheets are printed, images having a high image density and a small number of thin layer streaks and a small amount of fogging.

The image forming apparatus of the present disclosure can be utilized, for example, as a multifunctional peripheral or a printer to form images.

What is claimed is:

1. A non-magnetic one-component toner comprising:
a toner particle,
wherein the toner particle includes a toner base particle and an external additive that is adhered to a surface of the toner base particle,
the external additive includes a silica particle and a fluorine-containing particle and
in predetermined printing in which a standard test page image defined in ISO 19752 is printed on 1000 sheets of recording media,
a content Si₀ of the silica particles in the toner particles before the predetermined printing and a content Si_{1000D} of the silica particles in the toner particles in a development unit after the predetermined printing satisfy a formula (1) below, and
a content F₀ of the fluorine-containing particles in the toner particles before the predetermined printing and a content F_{1000D} of the fluorine-containing particles in the toner particles in the development unit after the predetermined printing satisfy a formula (2) below.
$$0.5 \leq {Si}_{1000 D} / {Si}_{0} \leq 1. \qquad ( 1 )$$
$$1. \leq {F}_{1000 D} / {F}_{0} \leq 1.5 \qquad ( 2 )$$

2. The non-magnetic one-component toner according to claim 1,
wherein the content Si₀ of the silica particles in the toner particles before the predetermined printing and a content Si_{1000C} of the silica particles in the toner particles in a cleaning unit after the predetermined printing satisfy a formula (3) below, and
the content F₀ of the fluorine-containing particles in the toner particles before the predetermined printing and a content F_{1000C} of the fluorine-containing particles in the toner particles in the cleaning unit after the predetermined printing satisfy a formula (4) below.
$$0.7 \leq {Si}_{1000 C} / {Si}_{0} \leq 0.9 \qquad ( 3 )$$
$$2. \leq {F}_{1000 C} / {F}_{0} \leq 2.5 \qquad ( 4 )$$

3. The non-magnetic one-component toner according to claim 1,
wherein a content of the silica particles in 100.0 parts by mass of the toner base particles before the predetermined printing is equal to or greater than 1.5 parts by mass but equal to or less than 2.5 parts by mass.

4. The non-magnetic one-component toner according to claim 1,
wherein a content of the fluorine-containing particles in 100.0 parts by mass of the toner base particles before the predetermined printing is equal to or greater than 0.3 parts by mass but equal to or less than 1.0 part by mass.

5. The non-magnetic one-component toner according to claim 1,
wherein a ratio WSi/WF of a content WSi of the silica particles in 100.0 parts by mass of the toner base particles before the predetermined printing to a content WF of the fluorine-containing particles in 100.0 parts by mass of the toner base particles before the predetermined printing is equal to or greater than 2.5 but equal to or less than 5.0.

6. The non-magnetic one-component toner according to claim 1,
wherein a number average primary particle diameter of the silica particles is equal to or greater than 12 nm but equal to or less than 40 nm, and
a number average primary particle diameter of the fluorine-containing particles is equal to or greater than 100 nm but equal to or less than 300 nm.

7. The non-magnetic one-component toner according to claim 1,
wherein the fluorine-containing particle is a fluororesin particle.

8. An image forming apparatus comprising:
an image carrying member; and
a development unit that supplies a non-magnetic one-component toner to an electrostatic latent image formed on a surface of the image carrying member,
wherein the non-magnetic one-component toner includes a toner particle,
the toner particle includes a toner base particle and an external additive that is adhered to a surface of the toner base particle,
the external additive includes a silica particle and a fluorine-containing particle and
in predetermined printing in which a standard test page image defined in ISO 19752 is printed on 1000 sheets of recording media,
a content Si₀ of the silica particles in the toner particles before the predetermined printing and a content Si_{1000D} of the silica particles in the toner particles in the development unit after the predetermined printing satisfy a formula (1) below, and
a content F₀ of the fluorine-containing particles in the toner particles before the predetermined printing and a content F_{1000D} of the fluorine-containing particles in the toner particles in the development unit after the predetermined printing satisfy a formula (2) below.
$$0.5 \leq {Si}_{1000 D} / {Si}_{0} \leq 1. \qquad ( 1 )$$
$$1. \leq {F}_{1000 D} / {F}_{0} \leq 1.5 \qquad ( 2 )$$

9. The image forming apparatus according to claim 8, further comprising:
a cleaning unit that collects the non-magnetic one-component toner from the surface of the image carrying member,
wherein the content Si₀ of the silica particles in the toner particles before the predetermined printing and a content Si_{1000C} of the silica particles in the toner particles in the cleaning unit after the predetermined printing satisfy a formula (3) below, and
the content F₀ of the fluorine-containing particles in the toner particles before the predetermined printing and a content F_{1000C} of the fluorine-containing particles in the toner particles in the cleaning unit after the predetermined printing satisfy a formula (4) below.
$$0.7 \leq {Si}_{1000 C} / {Si}_{0} \leq 0.9 \qquad ( 3 )$$
$$2. \leq {F}_{1000 C} / {F}_{0} \leq 2.5 \qquad ( 4 )$$
